(19) United States
(12) Patent Application Publication
(10) Pub. No.: US 2008/0024287 A1
(43) Pub. Date: Jan. 31, 2008

(54) Universal Tire Pressure Monitoring System and Wireless Receiver

(76) Inventors: Sean Robert Boyle, Ontario (CA); Vlad Ardelean, Ontario (CA); Douglas Scott Feagan, Ontario (CA)

Correspondence Address: HOWARD C. MISKIN;C/O STOLL, MISKIN, & BADIE, THE EMPIRE STATE BUILDING, 350 FIFTH AVENUE SUITE 4710, NEW YORK, NY, 10118, US

(21) Appl. No.: 11/597,702

(22) PCT Filed: May 25, 2005
(86) PCT No.: PCT/CA05/00792

§ 371 Date: Aug. 6, 2007

Related U.S. Application Data
(60) Provisional application No. 60/573,840, filed on May 25, 2004.

(51) Int. Cl. B60C 23/02

(52) U.S. Cl. 340/442; 701/29

(57) ABSTRACT

The present invention provides a universal receiver (OTR) device which functions within a vehicle in the “under-the-hood” (UTH) environment such that various types of tire pressure management system (TPMS) device, located within, upon or near a vehicle's tires can transmit tire information, such as the transmitter identification number (TIN), the tire unique identifier (TUID), the vehicle identification number (VIN), tire pressure, tire temperature, tire rotation, and other tire relevant data, to the OTR for further processing regardless of frequency, data transfer speed, or data format of the TPMS device. The OTR device in sequence: identifies the TPMS device, receives the tire information from the TPMS device, and processes the tire information into date records for efficient and optimized transmission of such data records for future analysis both within and off a vehicle. The OTR also interfaces with various types of telematics devices, regardless of the type of transmission or protocol used, by identifying the type of telematics device. The OTR also stores or retrieves information related to various telematics and TPMS devices in order to identify these devices. For example, an automotive manufacturer, dealership, or tire distributor would be able to select various manufacturers' TPMS and telematics devices for installation within the vehicle and with the OTR collect previously captured TPMS data for further analysis.

### FIELD OF THE INVENTION

The present invention relates to tire monitoring systems and to interfacing and decoding radio frequency signals generated by such systems. More particularly, the invention relates to telematics devices, which will allow wireless data transmission from the present invention to a data processing centre.

### BACKGROUND TO THE INVENTION

With hundreds of millions of tires being produced annually by the tire industry, tracking an individual tire throughout its entire life becomes a challenge. In addition to that challenge, there is a need to track different kinds of information related to tires. This information can be generally divided into two categories: 1) the information associated with the performance of tires while they are operating on a vehicle, i.e., pressure, temperature, mileage, tread depth, tire failures, retreadings, and warranty expirations, and 2) the information associated with servicing the tires in a garage, i.e., repairs, rotations, etc. There is a need to provide cradle-to-grave tire tracking and management of tire-related information.

Whether a tire manufacturing company or a tire service center, combined knowledge of both tire performance and servicing information can be invaluable to them. In the past, it has been impossible to track both sets of information. Manufacturing companies, for example, are unable to track their tires after they are sold to distributors. This is because distributors may install a set of tires on one vehicle and then, over the course of each tires' life, the tires may be rotated on a vehicle or at a later date installed on another vehicle. As there is no system that enables companies to determine the location and performance of their tires, there is a need for a solution to this dilemma.

Field performance information for a tire can also be invaluable to tire manufacturing companies. That information would allow manufacturers to do performance analysis on their tires based on “in the field” performance information and make modifications to their tire if defects are found.

It is well known in the art that tire pressure monitoring system (TPMS) devices are available to monitor tire inflation pressure and temperature. A typical TPMS consists of a receiver and a wireless sensor/transmitter that is attached to a valve stem, a rim, a tire's surface or even integrated right into the tire's rubber. TPMS devices communicate tire temperature and pressure along with other relevant TPMS data to a receiver on the vehicle at regular intervals.

However, individual TPMS systems are unable to archive or analyze the TPMS readings they generate over an extended period of time. The TPMS readings are also not integrated with other vehicle related data.

In addition, many vehicles are equipped with telematics devices. A telematics device is defined as a wireless communications system for the collection and dissemination of data. Applications of telematics devices commonly include vehicle-based electronic systems, e.g., mobile telephony, vehicle tracking and positioning, on-line navigation and information services and emergency assistance. While telematics devices communicate a wide array of vehicle information, communicating data related to vehicle tires has not been available to date.

Also, the TPMS and the telematics manufacturing industries are separate industries. As such, there are a wide variety of TPMS and telematics devices which are likely not directly compatible for communication purposes. It is not uncommon for each telematics manufacturer to have its own proprietary communication protocol and specific hardware communication requirements. Therefore, communication between a telematics device and a TPMS device requires that both have knowledge of their communication protocol and hardware requirements.

In view of the aforementioned shortcomings, there is a need to provide an industry-wide solution that tracks the location, performance, and servicing of a tire by seeking to provide a multifunctional TPMS which can communicate data related to tires off the vehicle for further performance analysis and tracking.

### SUMMARY OF INVENTION

The present invention provides a universal receiver device, referred to herein as the Omni TPMS Receiver (OTR) device, which functions within a vehicle (e.g. automobile, or fleet truck) in an “under-the-hood” (UTH) environment. The individual TPMS transmitters located within, upon or near a vehicle's tires, transmit tire data, such as transmitter identification Number (TIN), a tire unique identifier (TUID), a vehicle identification number (VIN), tire pressure, tire temperature, tire rotation, tire gravitational, acceleration change data and other tire relevant data, to the OTR device. The OTR device receives, collects and optionally analyzes the data, from any existing TPMS device as currently exists, or may be contemplated in the future. The OTR device also identifies and classifies all TPMS tire data types, stores the tire data and then optionally analyzes such data. The analysis enables efficient and optimized movement and/or transmission of such data for future analysis both within and off the vehicle. The OTR also stores or retrieves information related to the various telematics and TPMS devices in order to identify these devices.

According to the present invention, the OTR device is able to receive, capture and process information from differently manufactured TPMS devices, regardless of frequency, data transfer speed or data format. The data processing inside the OTR device consists of data validation, data analysis and data preparation for transmission to a telematics device, which will transfer the processed information to an enhanced processing center (e.g., a remote computer equipped with specialized software).

The OTR device also interfaces with various telematics devices, regardless of the type of transmission or communication protocol used. To interface with the telematics device, the OTR identifies the type of telematics device, the transmission type and communication protocol required to then reliably send the information to the processing centre.

The present invention is advantageous in that an OEM automotive manufacturer, dealership, garage, tire distributor or other such tire service provider would be able to select from among various manufacturers' TPMS and telematics solutions for installation within the vehicle. The installation of the OTR device enables the user to capture TPMS data for future analysis.

The present invention in combination with other tire tracking systems facilitates the complete intelligent analysis of a vehicle's tires. In addition, the OTR device can generate, or provide the interface to the processing center which generates, reports on how tires impact the rest of the vehicle and the fleet's performance, as well as the overall cost associated with tire maintenance.

In a first aspect, the present invention provides a universal receiver device for interfacing between a tire pressure management system (TPMS) device, operatively installed to capture information associated with a vehicle's tire, and a telematics device, capable of wirelessly transmitting processed information to a remote processing unit, the universal receiver device comprising: a receiver unit, operatively connected to a transmitter of the TPMS device, having a sensor discriminator for identifying a type of TPMS device to communicate therewith, and for receiving the information associated with a vehicle's tire, previously captured by the TPMS device, in a communication format associated with the identified TPMS device; a processing unit, operatively coupled to the receiver unit, for processing the information into at least one data record; and a data transmission unit, operatively coupled to the processing unit, having a telematics discriminator for identifying a type of telematics device to communicate therewith, and for forwarding the at least one data record in a communication format associated with the identified telematics device.

In a second aspect, the present invention provides a method of interfacing between a tire pressure management system (TPMS) device, operatively installed to capture information associated with a vehicle's tire, and a telematics device, capable of wirelessly transmitting processed information to a remote processing unit, comprising steps of: a) identifying a type of TPMS device to communicate therewith; b) receiving the information associated with a vehicle's tire, previously captured by the TPMS device, in a communication format associated with the identified TPMS device in step a); c) processing the information into at least one data record; d) identifying a type of telematics device to communicate therewith; and e) forwarding the at least one data record in a communication format associated with the identified telematics device in step d).

### BRIEF DESCRIPTION OF THE DRAWINGS

The present invention will now be described with reference to the Drawings, in which:

FIG. 1 is a high-level functional block diagram of an OTR device according an aspect of the present invention;

FIG. 2 is a detailed block diagram of the OTR device of FIG. 1;

FIG. 3 is a connection block diagram showing the OTR device of FIG. 1, a TPMS front end receiver and a telematics device connected according to an aspect of the present invention;

FIG. 4 is a schematic drawing showing an example of a relay and optical interface for communication between the OTR device, the TPMS front end receiver and the telematics device of FIG. 3;

FIG. 5 is a flowchart of the process of the OTR device of FIG. 1;

FIG. 6 is a detailed flowchart of the TPMS identification process initiated in the process of FIG. 5;

FIG. 7 is a detailed flowchart of the telematics identification process initiated in the process of FIG. 5;

FIG. 8 is a flowchart detailing an example of a source validation and filtering process for a specific TPMS manufacturer in accordance with an aspect of the present invention;

FIG. 9 is a communication state flow chart for a telematics unit according to an aspect of the present invention.

### DETAILED DESCRIPTION OF THE INVENTION

The invention will be described for the purposes of illustration only in connection with certain embodiments. However, it is to be understood that other objects and advantages of the present invention will be made apparent by the following description of the drawings according to the present invention. While a preferred embodiment is disclosed, this is not intended to be limiting. Rather, the general principles set forth herein are considered to be merely illustrative of the scope of the present invention and it is to be further understood that numerous changes may be made without straying from the scope of the present invention.

For the purposes of this document, a stub is defined as a small program routine that substitutes for a longer program, possibly to be loaded later or that is located remotely. For example, a main program that uses remote procedure calls (RPCs) is compiled with stubs that substitute the main program for a requested procedure. The stub accepts the request and then forwards it (through another computer program) to a remote procedure. When that procedure has completed its service, it returns the results or other status to the stub which passes it back to the main program that made the request.

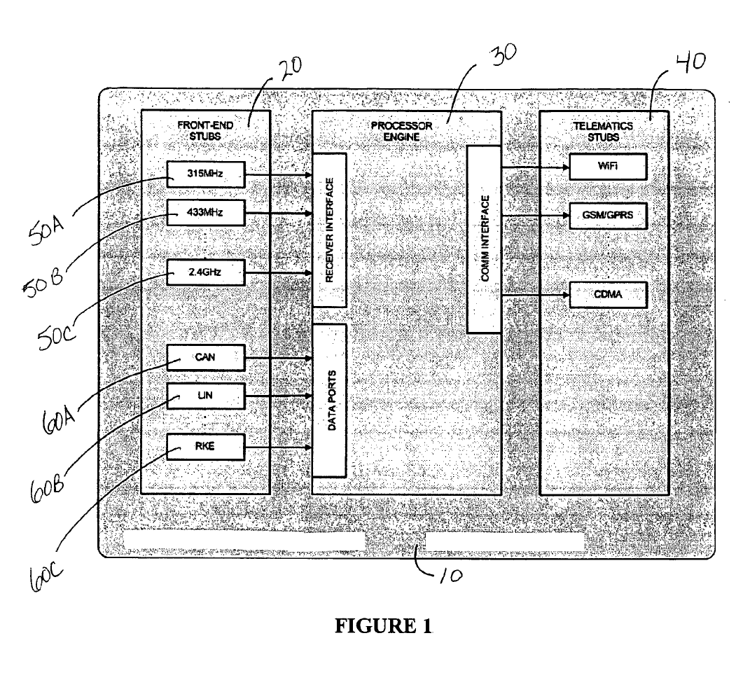

FIG. 1 shows a high-level functional block diagram of a OTR device 10. The OTR device comprises a front-end receiver 20, a data processing engine 30, and a data transmission port 40.

The front-end receiver 20 is built in modules. The OTR 10 accommodates several modules (stubs) in order to correctly receive information from various TPMS transmitters and sensors. The modules are classified based on: 1) frequency used (i.e. 125 kHz, 315 MHz 50A, 433 MHz 50B, 900 MHz, 2.4 GHZ 50C, etc.); 2) type of modulation (i.e. amplitude-shift-keying (ASK), frequency-shift-keying (FSK), on-off keying (OOK), etc.); and 3) brand of TPMS transmitter or sensor. In addition to the front-end receiver 20, several. data ports allow for interfacing with a vehicle's existing TPMS receivers, such as a controller area network (CAN) 60A, local interconnect network (LIN) 60B, serial (RS232) and remote keyless entry (RKE) 60C ports.

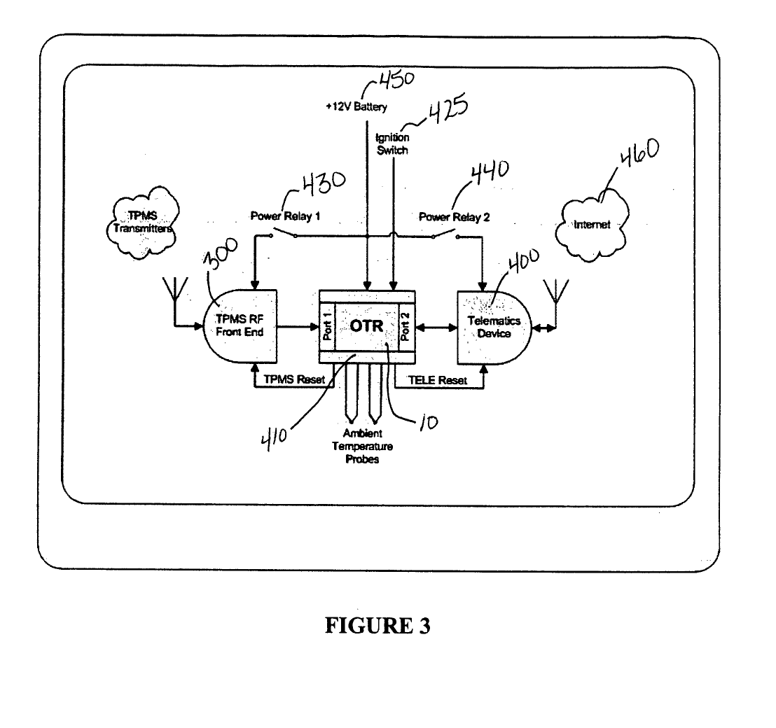

The data processing engine 30 executes a plurality of functions. The engine 30 decodes the data from different modulation schemes and line coding (i.e. Manchester, non-return-to-zero (NRZ), return-to-zero (RZ), etc.). The engine 30 performs data integrity checks and data recovery based on single error correction techniques known to those having ordinary skill in this art. The engine 30 also performs data validation based on the receiver's initialization parameters. The data received by the engine 30 is broken into data blocks using the methodology of an embodiment of the present invention. The engine then formats the processed data into a data stream to be sent out to a processing center (not shown) via a telematics device (shown in FIG. 3).

The data transmission port 40 has the capability of communicating with various telematics devices (not shown). The data port classification method is based on: 1) physical port type (i.e. RS232, universal serial bus (USB), Ethernet, etc.); 2) transmission Speed (i.e. Baud Rate); and 3) communication protocol (packet assembler/disassembler (PAD), serial, point-to-point protocol (PPP), serial line internet protocol (SLIP), transmission control protocol/Internet protocol (TCP/IP), etc.); and 4) telematics transmission types such as WiFi (wireless fidelity), ZigBee™, and BlueTooth™ communication protocols, global positioning system (GPS), global system for communications and general packet radio service (GSM/GPRS), and code division multiple access (CDMA), etc.

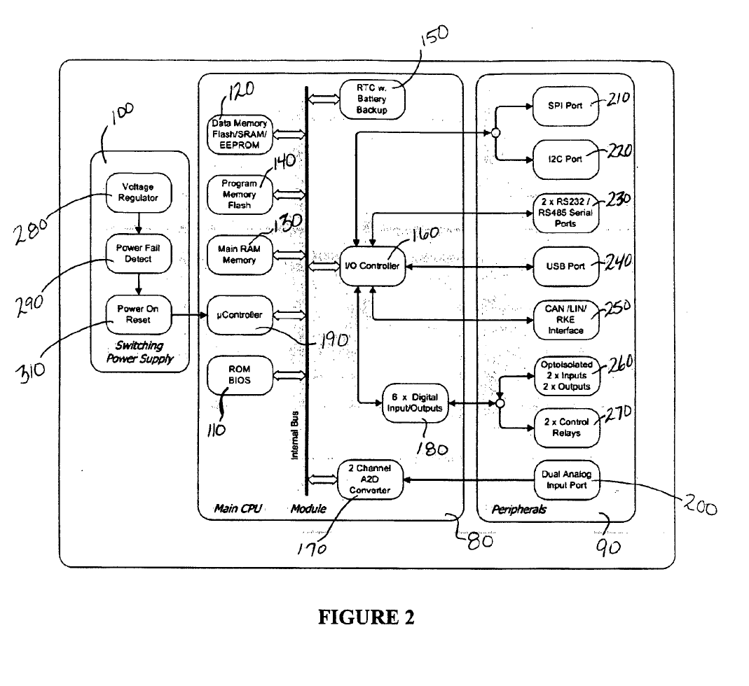

FIG. 2 shows a detailed hardware block diagram of the OTR device 10 of the present invention. The OTR device 10 includes a main central processing unit (CPU) module 80, peripherals 90 (i.e., communication ports, analog input interface, output relays), and a switching power supply 100. The data processing engine 30 forms part of the main CPU module 80.

The term ‘embodied’ referred to herein means that an executable software version of given module can run as a computer program on a microprocessor, microcontroller, or comparable semiconductor-based device resident on the OTR device 10. The main CPU module 80 is embodied as programmed logic instructions stored in either a micro controller or a micro processor (not shown). In addition, the main CPU module 80 includes a basic input/output system (BIOS) 110. The (BIOS) 110, embodied either in a ROM, or Flash type of memory, loads upon start-up the required information (i.e., software code) to access the OTR components, such as the data memory 120 and the peripherals 90.

Suitable minimum memory requirements for the OTR processes to run are: random access memory (RAM) 130 (static or dynamic) of at least 512 Kb; program memory flash 140 of at least 512 Kb; and data memory 120 (flash disk, battery backed-up static random access memory (SRAM) or electrically erasable programmable read-only memory (EEPROM)) of at least 512 Kb.

In addition, the main CPU module 80 includes a battery backed-up real time clock (RTC) 150, an input/output (I/O) controller module 160, and an analog to digital (A/D) converter 170. The purpose of the RTC 150 is to keep the time updated even when the OTR device 30 is powered off, thus saving energy when the vehicle is not running. An I/O controller module 160 manages a plurality of input/output ports (digital I/O ports) 180, the communication ports to the peripherals 90 and a microcontroller 190 which controls the switching power supply 100. The two channel analog inputs at the A/D converter 170 read information from the analog interface 200 and convert it into a digital stream of data for the micro controller 190. A suitable minimum recommended resolution for the A/D converter 170 is 10 bits.

In accordance with FIG. 2, the peripherals 90 are utilized to interface with various TPMS radio frequency (RF) front end receivers and Telematics devices (shown in FIG. 3). The peripherals 90 include a series of ports: a serial peripheral interface (SPI) port 210, an intelligent interface controller (I2C) port 220, serial ports (recommended standard (RS) 232, RS 485) 230, a USB port 240, CAN/LIN/remote keyless entry (RKE) interface 250, optoisolated I/Os 260, and control relays 270.

A TPMS RF front end receiver 300, shown in FIG. 3, is a module that plugs in one of the available peripheral ports 90 (e.g., RS232 230, SPI 210, I2C 220, CAN, LIN, RKE 250). A telematics device 400, also shown in FIG. 3, is a wireless transmitter (wireless modem) that plugs into one of the available ports, such as RS232 230 or USB 240. It is understood that the TPMS RF front end receiver 300 reports data from all tires on a vehicle.

The OTR device 10 also includes the switching power supply 100 which is operatively coupled to the microcontroller 190. The switching power supply includes a voltage regulator 280, a power fail detect circuit 290, and a power on reset circuit 310 directly coupled to the microcontroller 190. The switching power supply 100 allows the main core module 80 and peripherals 90 to operate in a range from approximately 8 VDC to 42 VDC. The power supply should be optimized for best efficiency at 12V to preserve the life of the vehicle's battery. The power-on reset circuit 310 allows the microcontroller 190 to be reset during the power-on cycle. The power fail detect circuit 290 allows the OTR main computer program to save all available information prior to shutting down the power on the OTR 10.

Referring now to FIG. 3, an OTR device connection diagram is shown. The OTR device 10 includes a dual channel analog interface block 410 used to collect information on the ambient temperature from two different points on a vehicle (not shown). The two digital inputs (digital I/O) 180 (shown in FIG. 2) are optically isolated ports used to sense information from different points in the vehicle, such as the ignition switch 425 and the engine switch on/off (not shown), as well as to control the TPMS RF front end receiver 300 and the telematics device 400. There are also two controlled relays 430, 440 provided to turn the power on or off to the TPMS RF front end receiver 300 and to the telematics device 400 to save the vehicle's battery 450 when the vehicle engine (not shown) is not running.

As previously mentioned, the OTR program can accommodate several modules (stubs) in order to correctly receive information from various TPMS transmitters and sensors. The stubs for the TPMS RF front-end receivers are typically classified based on: 1) the port required to interface with the OTR (RS232, I2C, SPI, CAN); 2) the brand of TPMS transmitter or sensor; 3) frequency used (i.e. 315 MHz, 433 MHz, 900 MHz, 2.4 GHZ, 125 kHz RFID, etc.) and 4) the type of modulation (i.e. ASK, FSK, OOK, etc.). It should also be mentioned that only one TPMS RF front-end receiver stub is used in any given period of time.

As such and in accordance with the embodiment of the present invention, the OTR device can communicate with several telematics device stubs through the corresponding communication ports. The telematics device are typically classified based on: physical port type (i.e. RS232, USB, Ethernet, etc.); 2) transmission speed (i.e. Baud Rate); 3) communication protocol (PAD, Serial, PPP, SLIP, TCP/IP, etc.); and 4) telematics transmission type (WiFi, ZigBee™, BlueTooth™, GPS, GSM/GPRS, CDMA, etc.).

The main OTR computer program embodied in the microcontroller 190 has the capability of detecting the type of TPMS RF front-end receiver and the port used for the TPMS, and similarly the type and port of the telematics device during the start-up initialization process. To prevent vehicle battery drainage, the OTR computer program continuously monitors the status of the engine ignition switch (on or off), and decides if the TPMS and the telematic device should be powered on or off. This decision is based on the time delay from when the ignition was switched off. A running error status loop in the main OTR computer program will also monitor the correct activity of the OTR 30 and reset the microcontroller 180 in case of a fault.

According to the present invention, the TPMS raw data is then processed as it arrives into a designated communication port for example, PORT 1, in FIG. 3 of the OTR device 10. The processed data is then packed into a data record (not shown) and then later sent through another designated communication port (PORT 2 for example) through to the telematics device 400. The telematics device 400 may then send the data through the Internet 460, for example, to a data processing and data management server (not shown), or a proprietary data portal, such as the TireStamp™ server. At transmission time, the OTR device must connect to the Telematics device 400 to send the packed record. Upon successful transmission, the packed data record is deleted and a new data record is created in the OTR device 10.

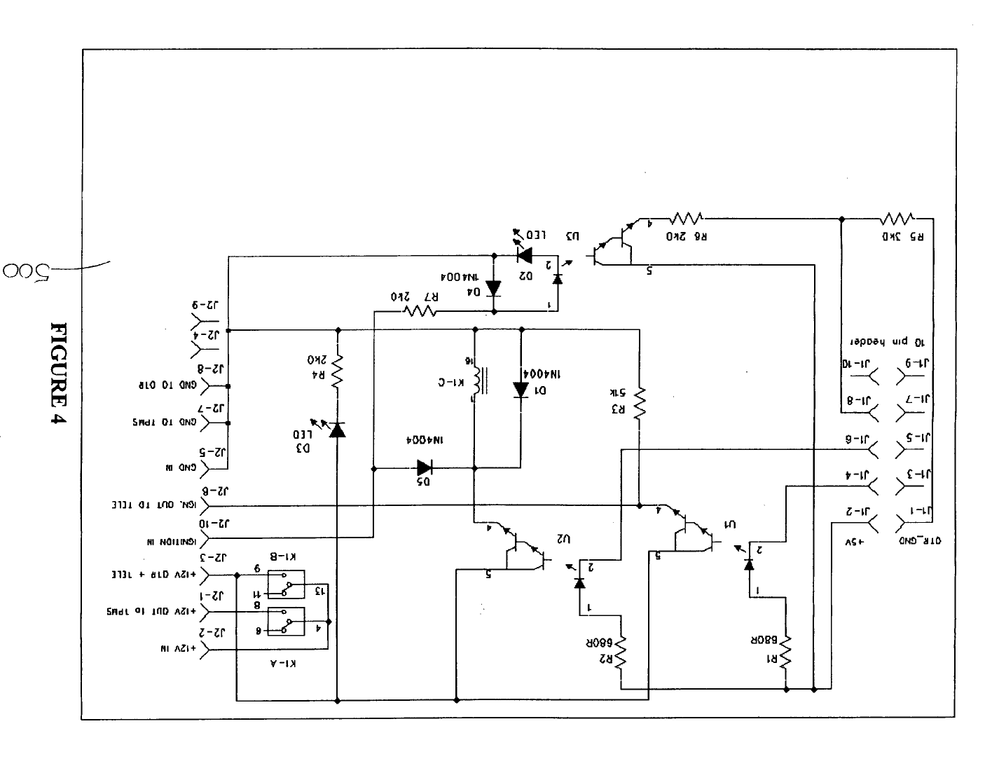

It should be mentioned that the main CPU module 80 and peripherals 90 of the OTR device 10 may be embodied in programmed microcontroller circuits. The OTR device 10 controls power to the TPMS front end receiver 300 and the telematics device 400 via an optical relay interface. FIG. 4 shows an example of a relay and optical interface 500 schematic for this purpose.

Referring now to FIG. 4, connectors J1-1, J1-2, . . . J1-10, form part of the OTR peripherals 90, and are used to isolate the optical interface 500 from the peripherals 90 and the main CPU module 80. Connectors J2-1, J2-2, . . . J2-10, are attached as physical connectors from the OTR device 10 to allow interfacing with the TPMS RF receiver 400 and the telematics unit 300.

Three optocouplers U1, U2 and U3 protect the OTR device 10 against high voltage transients on the inputs and against possible ground loop noisy currents. The power source (+12V) from the vehicle's battery (not shown) is routed to the TPMS and the telematics devices respectively through a dual pole relay K1-A, K1-B. The LED indicators D2 and D3 are used for status monitoring. The diodes D1 and D4 protect the optocouplers against high voltage reverse biasing currents.

According to an aspect of the present invention, upon connection to the vehicle's power source on connector J2-2, the OTR device 10 does not power up. Rather, the ignition switch is monitored via connector J2-10. When the ignition switch is powered to +12V, the relay K1 energizes applying power to the OTR device 10 and at the same time through K1-A and K1-B contacts connected respectively to the telematics device 400 and the TPMS RF front-end receiver 300 (shown in FIG. 3).

It should be noted that the circuit shown in FIG. 4 may be more defined to separate the power supplied to the telematics and the TPMS devices respectively, through two independent relays, representatively shown as part of the OTR peripherals 90, as control relays 270.

In FIG. 4, the OTR microcontroller 190 (not shown) is programmed to monitor the status of the ignition switch via the optocoupler U3 at the connector pin J1-8. Based on the signal output at this pin, the OTR device 10 decides whether to remain active or retreat into a power saving shut-down mode. A first reset signal from the OTR device 10 is fed from the J1-4 connector, into the U1 optocoupler and in turn to the J2-8 connector to set the ignition of the telematic device. A second reset signal to the TPMS RF front end receiver may be sent from the OTR peripherals 90 to the TPMS RF front end receiver 300.

Further in reference to FIG. 4, a relay K1 is maintained energized by the optocoupler U2. As such, even if the ignition is turned off, the OTR device 10 will continue to be powered until the OTR computer program initiates a power saving mode. The optocoupler U2 is activated by the OTR program through the J1-6 connector.

It is understood that the OTR computer program can run under a disk operating system (DOS) environment. However, the recommended environment for this application is a real time operating system (RTOS). The OTR computer program described herein may be written in C, C++, and/or assembly computer languages.

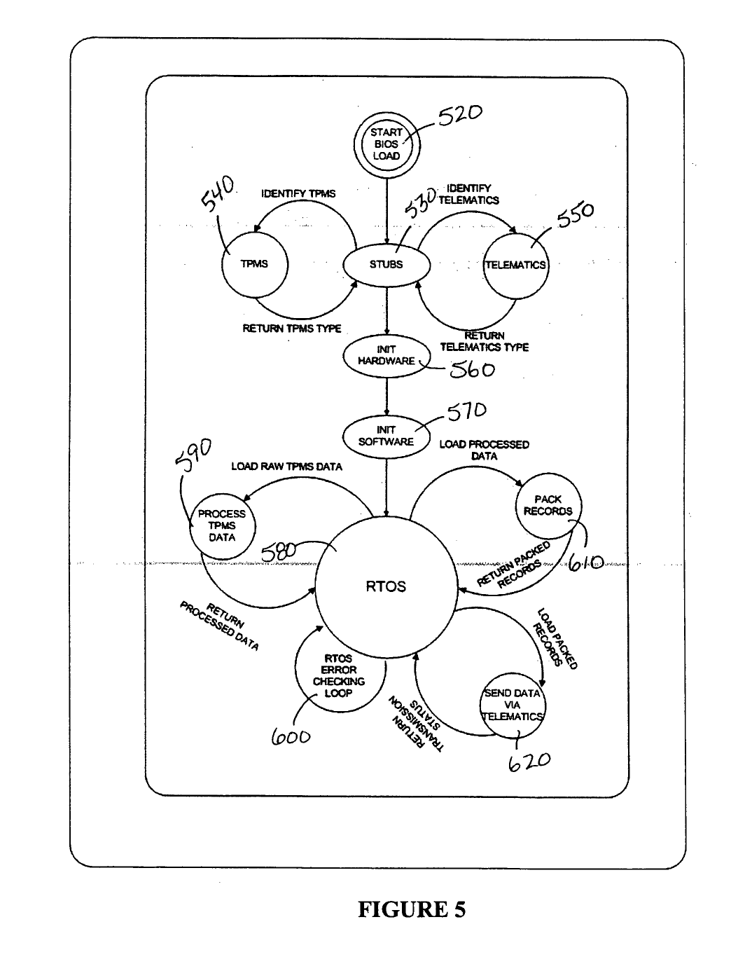

FIG. 5 is a state diagram showing the process flow 510 of the OTR computer program. Upon powering up, the OTR process first loads the required code in the computer program embodied on the existing hardware. Step 520 represents the BIOS boot loading which is part of the operating system environment of the OTR device. Next, the process initiates stubs in step 530. A first stub identifies the TPMS RF receiver type and port used in step 540, and returns the TPMS related information to the OTR. A second stub identifies the telematics device type and port used in step 550, and returns the telematics related information to the OTR. After a successful identification of the TPMS RF and the telematics units, the process initializes the remaining peripheral modules (A/D, relay and optical isolated controls) in step 560. Next, the process initiates the software initialization protocol in step 570. The process then initiates the RTOS in step 580 to collect, process, and transmit raw TPMS data. The RTOS initiates the next step 590 of processing TPMS data by loading the raw TPMS data and returning same to the RTOS for processing. Next, the RTOS performs an error checking procedure loop in step 600 to check the raw data. In step 600 the raw data may be validated using a double error detection and single error correction mechanism, followed by data source identification, filtering and error tracking mechanisms. The RTOS then proceeds to load the processed TPMS data to pack the data into records in step 610. Process step 610 returns the packed records to the RTOS. Finally, in step 620, the RTOS loads the packed records and sends the data records via the telematics to a further processing unit either on board the vehicle or remotely located.

It should be mentioned that the TPMS RF receiver may have an error detection and correction mechanism built in which would eliminate step 600 from the OTR process flow.

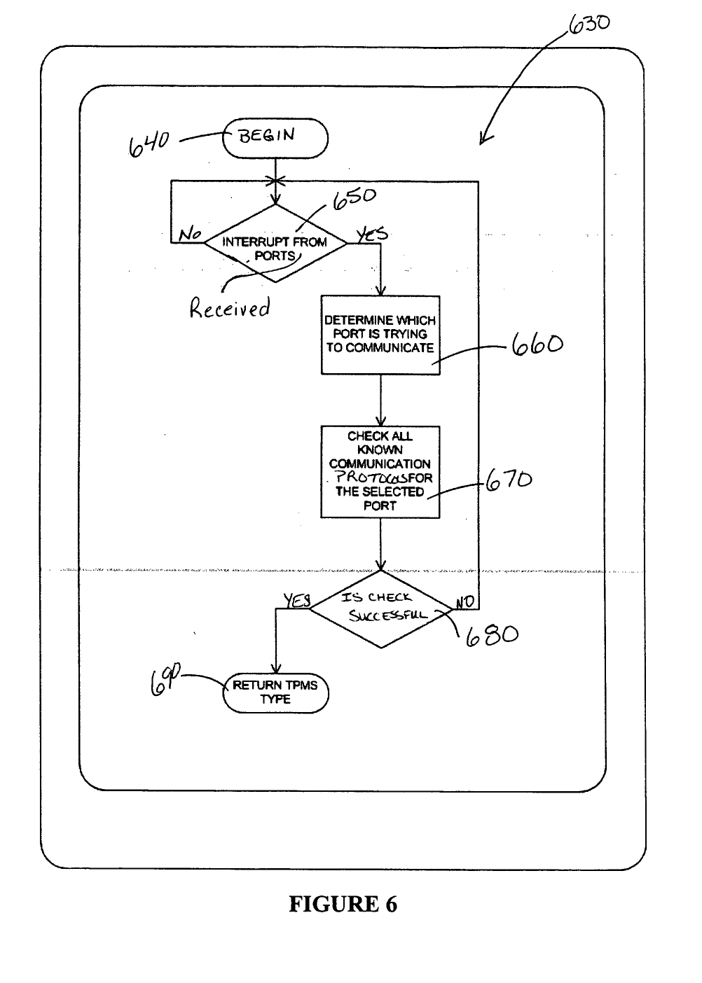

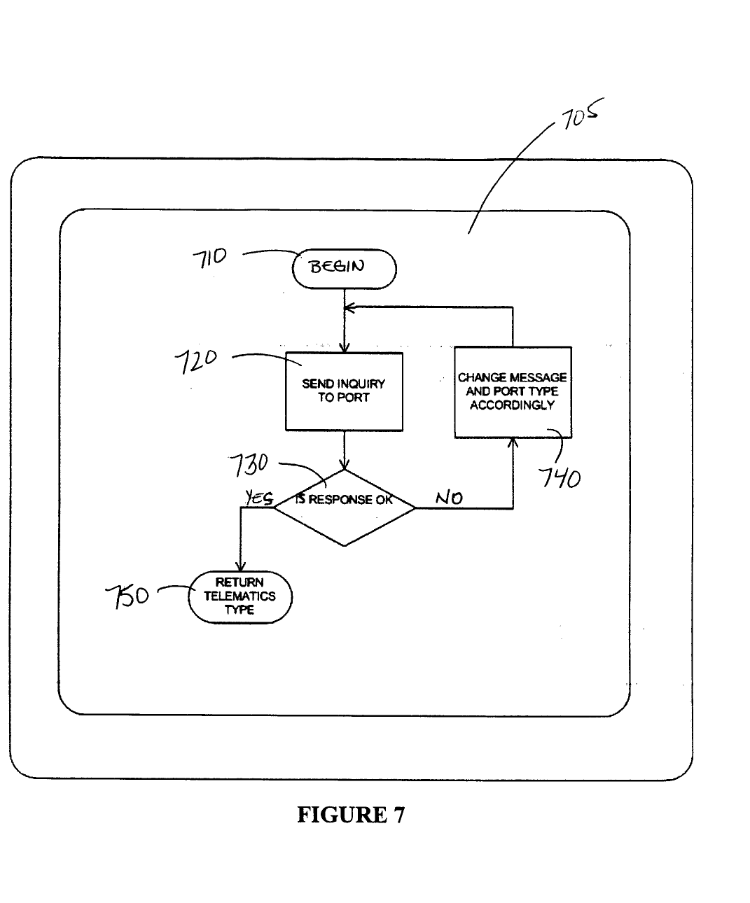

FIGS. 6 and 7 show flow charts 630, 705 further detailing the respective TPMS and telematics identification processes. Upon a successful identification of the respective device, each process returns to the main OTR program a set of variables containing all the required information to properly communicate with the attached device.

In FIG. 6, the TPMS identification process 630 is detailed in a flowchart. The process begins at step 640 and waits for an interrupt signal at one of the existing ports, at decision step 650. If the process receives an interrupt then the process continues to step 660, otherwise the process waits for an interrupt signal in step 650. Upon receiving the interrupt signal in step 650, the process determines which TPMS device port is communicating with the OTR device and assigns the port a value in step 660. Next, in step 670, the process collects information from that particular port to check for known TPMS protocols and data format stored in the OTR device's memory. The process then determines whether the data format has been successfully decoded, in decision step 680. If successful, step 690 returns a set of environment variables containing information regarding the TPMS RF receiver and then exits the process to return to the OTR stubs, at step 530, shown in FIG. 5. If no known TPMS data format is detected by the OTR device, the RTOS times out, the processor is reset, and the process returns to step 650.

In FIG. 7, the telematics detection process 705 is detailed in a flowchart. The process begins at step 710. The process then acknowledges the telematics device type by sending an inquiry, in a known format, to the appropriate port and waiting for the correct response in step 720. According to the decision step 730, which follows step 720, if the inquiry receives the correct response, the process proceeds to a final step 750. Otherwise, the process follows step 740 and changes the message and port type to send another inquiry at step 730. Upon receipt of the correct response at step 730, the process proceeds, at step 750, to set the environment variables describing the type of telematics device and port used and then exits the process to return the OTR stubs, at step 530, shown in FIG. 5. If no known telematics device is detected, the RTOS times out and the processor is reset.

The hardware and software initializations, steps 560 and 570, discussed with reference to FIG. 5, are performed upon successfully loading the TPMS and the telematics environment variables. The hardware initialization, step 560, consists in setting the communication ports, A/D decoders and I/O interfaces to the correct values. The software initialization, step 570, reads the required information from an OTR data file located in the OTR device's memory.

According to FIG. 5, after completing the software initialization step 570, the process starts collecting TPMS raw data information from the TPMS RF front end receiver coupled to the OTR.

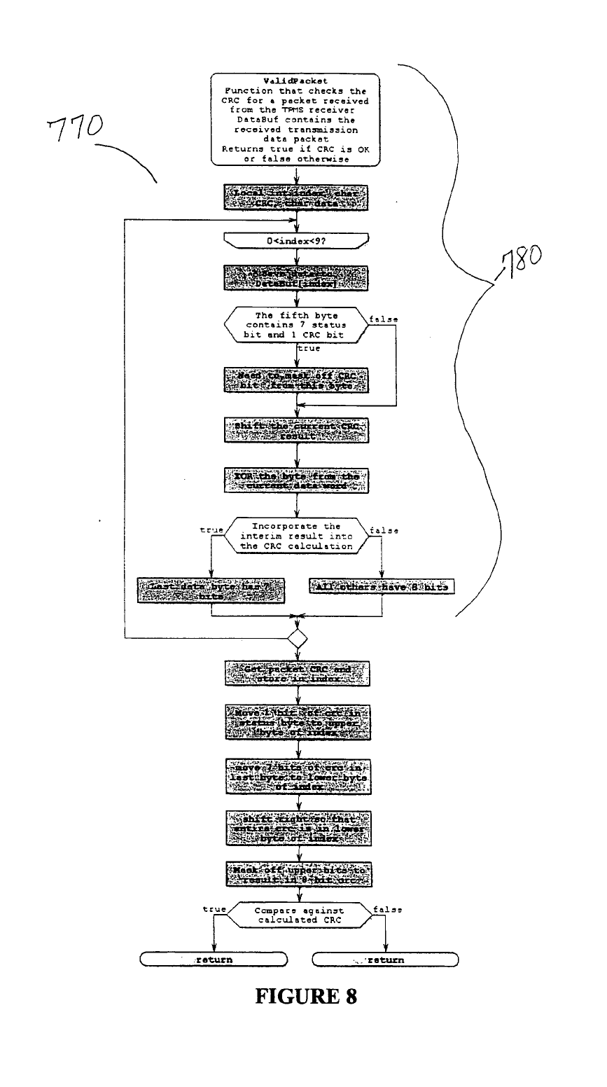

FIG. 8 is a flowchart 770 showing an example of a source validation and filtering process for a specific manufacturer's TPMS device. For this TPMS device, the TPMS data validation process is executed using a manufacturer's proprietary cyclic redundancy check (CRC) algorithm 780.

Finally, once the TPMS data has been validated and filtered, the OTR may generate statistical analysis: calculate a running average for acquired TPMS data over a certain period of time, and calculate minimum, maximum and last transmitted values. The OTR may also count the number of errors during transmission over a period of time to assess the TPMS transmitter's reliability.

According to the present invention, the tire data is extracted from the TPMS data stream and parsed into a temporary data structure. The temporary data structure will later form a packed record suitable for transmitting to the telematics device as detailed in the OTR process of FIG. 5. The packed records are then transmitted to a processing unit by means of the telematics device.

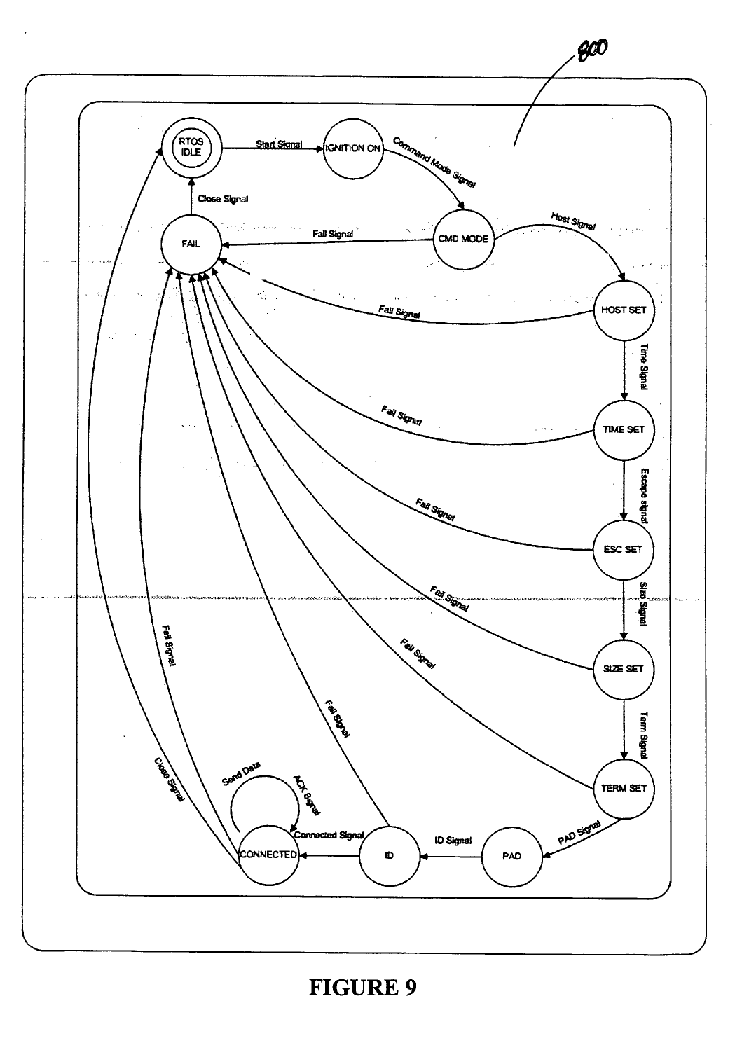

FIG. 9 is a communication state flow chart 800 for communication with a particular telematics unit which represents the internal operation of the RTOS for Packet Assembler/Disassembler (PAD) type of communication. The loop first checks ignition status to see if the engine of the vehicle has been turned on or off. If the engine is on, it starts communicating to the modem in command mode, sets the PAD communication parameters and escape sequence and initiates PAD communication and data transfer.

According to the present invention, a proprietary TireStamp™ Communication Protocol (TSCP) establishes how the OTR device will communicate with a proprietary telematics unit. The TSCP protocol is a type of Connection-Oriented Service protocol. As such, any of the connected devices should be able to query the other device to initiate communication. According to the TSCP of the present invention, either the OTR device or the telematics device can initiate a connection by sending a request. The request can either be accepted or rejected. If the request is refused, the connection fails, otherwise the connection is established.

The TSCP protocol is based on the International Consultative Committee for Telegraphy and Telephony (CCITT), known as the International Telecommunication Union (ITU) since 1993, X.25 protocol. The X.25 protocol is a packet switched data network protocol which defines an international recommendation for the exchange of data as well as control information between a user device (host), called Data Terminal Equipment (DTE) and a network node, called Data Circuit Terminating Equipment (DCE). The X.25 protocol utilizes a connection-oriented service. In connection-oriented service, the end node first informs the network it wishes to start a conversation with another end node, the network sends the request to the destination that accepts or rejects the request. If the destination refuses, a connection fails, otherwise a connection is established. This service insures that packets are transmitted in order. The X.25 protocol includes three levels based on the first three layers of the Open Systems Interconnection (OSI) seven layer. For the purposes of this document, the same definitions used by CCITT are adapted for the communication devices (the OTR device and the telematics device): Data Terminal Equipment (DTE) and Data Communication Equipment (DCE). In the present invention, both communication devices (the OTR device and the telematics device) can be a DTE or a DCE, depending on the direction of communication. The TSCP protocol is a simplified version of the X.25 protocol.

The table below shows an example of a proprietary OTR data record definition that may be utilized to transmit data to the telematics device according to the TSCP.

| Byte | Abbreviation | Description |
|---|---|---|
| 1 | TIR1ID3 | Tire# ID - 4 bytes |
| 2 | TIR1ID2 | ″ |
| 3 | TIR1ID1 | ″ |
| 4 | TIR1ID0 | ″ |
| 5 | SENS | Sensor type (Low range or high range) |
| 6 | GTC1 | Good transmissions counter byte 1 |
| 7 | GTC0 | Good transmissions counter byte 0 |
| 8 | BTC1 | Bad transmissions counter byte 1 |
| 9 | BTC0 | Bad transmissions counter byte 0 |
| 10 | PAVG | Average tire pressure for the last hour (or since |
| | | last Tx) |
| 11 | PMAX | Max (peak) tire pressure in the last hour (or since |
| | | last Tx) |
| 12 | PMIN | Min. tire pressure in the last hour (or since last |
| | | Tx) |
| 13 | PLAST | Last valid pressure measurement |
| 14 | TAVG | Average tire temperature for the last hour (or since |
| | | last Tx) |
| 15 | TMAX | Max(peak) tire temperature in the last hour (or since |
| | | last Tx) |
| 16 | TMIN | Min. tire temperature in the last hour (or since last |
| | | Tx) |
| 17 | TLAST | Last valid temperature measurement |
| 18 | BAT | Battery level in tire sensor (last reading only) |
| 19 | LIFE | Life counter data from tire sensor (last reading only) |
| 20 | STAT | Tire sensor status (last reading only) |
| 21 | TUID_7 | TUID_7 |
| 22 | TUID_6 | TUID_6 |
| 23 | TUID_5 | TUID_5 |
| 24 | TUID_4 | TUID_4 |
| 25 | TUID_3 | TUID_3 |
| 26 | TUID_2 | TUID_2 |
| 27 | TUID_1 | TUID_1 |
| 28 | TUID_0 | TUID_0 |
| 29 | NULL | Reserved |
| 30 | NULL | Reserved |
| 31 | NULL | Reserved |
| 32 | NULL | Reserved |

With respect to the TSCP data record format, at the end of every predetermined period of time, e.g., one hour, a file will be generated containing information about the vehicle and its tires, the data record should contain a data packet header; and ‘n’ data packets (where ‘n’ is the number of tires on the vehicle being monitored).

The data packet header may also contain information as follows:
Time at which the data record was created (e.g. 6 bytes in length)
OTR unit ID (serial#) for identification (e.g. 4 bytes in length)
OTR computer program version (e.g. 2 bytes in length)
Telematics unit ID (e.g. 2 bytes in length)
TPMS system ID (e.g. 2 bytes in length)
VIN number (e.g. 8 bytes in length)
Total number of bad transmissions (errors) per vehicle, (e.g. 2 bytes in length)
Odometer reading may be optionally implemented (e.g. 4 bytes in length)

The data record may also contain ‘n’ OTR data packets, one per tire. The following describes the header information in the data packet.

| File | | |
|---|---|---|
| Section | Bytes | Description |
| Header | 32 | |
| Bytes | | |
| 1-6 | 6 | Time of record |
| 7-10 | 4 | OTR unit ID (serial#) for identification |
| 11-11 | 2 | OTR computer program version |
| 13-14 | 2 | Telematics mfg. and unit ID |
| 15-16 | 2 | TPMS system ID |
| 17-24 | 8 | VIN number |
| 25-26 | 2 | Total number of bad transmissions (errors) per vehicle |
| 27-30 | 4 | Odometer reading in km |
| 31-32 | 2 | Ambient temperature in deg. ° C., offset to −40deg. |
| | | ° C. |
| Body | n × 32 | |
| Bytes | | |
| 31-64 | 32 | data packet 1 |
| 65-96 | 32 | data packet 2 |
| 97-. . . | . | . |
| . . . | . | . |
| . . . | . | . |
| . . . | 32 | data packet n |

With respect to file naming, each file may have a format (e.g. a DOS short file naming scheme limitation).

With respect to file compression, all files may be transmitted from an OTR device as zipped files. For secure transmission, a password can also be assigned to the zipped file.

The present invention incorporates herein by reference the following references: TANENBAUM, A.: “Computer Networks,” Prentice-Hall, Inc, 1981; and SIAN, K.: “Inside TCP/IP,” Third Ed., New Riders Publishing, 1997.

The present invention can be implemented in digital electronic circuitry, or in computer hardware, firmware, software, or in combination thereof. Apparatus of the invention can be implemented in a computer program product tangibly embodied in a machine-readable storage device for execution by a programmable processor; and methods actions can be performed by a programmable processor executing a program of instructions to perform functions of the invention by operating on input data and generating output. The invention can be implemented advantageously in one or more computer programs that are executable on a programmable system including at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and specific microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in ASICs (application-specific integrated circuits).

Examples of such types of computers are programmable processing systems contained in performing the apparatus or methods of the invention. The system may comprise a processor, a random access memory, a hard drive controller, and an input/output controller coupled by a processor bus.

It will be apparent to those skilled in this art that various modifications and variations may be made to the embodiments disclosed herein, consistent with the present invention, without departing from the spirit and scope of the present invention.

Other embodiments consistent with the present invention will become apparent from consideration of the specification and the practice of the invention disclosed therein.

Accordingly, while the invention has been described according to what is presently considered to be the most practical and preferred embodiments, the specification and embodiments are to be considered exemplary only. Those having ordinary skill in this art will readily recognize that various modifications and equivalent structures and functions may be made without departing from the spirit and scope of the invention. Therefore, the invention must be accorded the broadest possible interpretation so as to encompass all such modifications and equivalent structures and functions, with a true scope and spirit of the invention being disclosed by the following claims.

Having thus described the invention, what is claimed as new and secured by Letters Patent is:

1. A universal receiver device for interfacing between a tire pressure management system (TPMS) device, operatively installed to capture information associated with a vehicle's tire, and a telematics device, capable of wirelessly transmitting processed information to a remote processing unit, the universal receiver device comprising:
a receiver unit, operatively connected to a transmitter of the TPMS device, having a sensor discriminator for identifying a type of TPMS device to communicate therewith, and for receiving the information associated with a vehicle's tire, previously captured by the TPMS device, in a communication format associated with the identified TPMS device;
a processing unit, operatively coupled to the receiver unit, for processing the information into at least one data record; and
a data transmission unit, operatively coupled to the processing unit, having a telematics discriminator for identifying a type of telematics device to communicate therewith, and for forwarding the at least one data record in a communication format associated with the identified telematics device.

2. The universal receiver device as in claim 1, wherein the processing unit comprises means for storing the at least one data record.

3. The universal receiver device as in claim 2, wherein the sensor discriminator comprises means for storing communication information specific to at least two types of TPMS devices, and wherein the telematics discriminator comprises communication information specific to at least two types of telematics devices.

4. The universal receiver device as in claim 1, wherein the processing unit is a semiconductor-based device resident on the universal receiver device.

5. The universal receiver device as in claim 1, wherein the at least one data record comprises transmission type and communication protocol information required to communicate with the telematics device.

6. The universal receiver device as in claim 1, wherein the OTR device is comprised of a main central processing unit (CPU) module and peripherals, wherein the main CPU module is operatively coupled to the peripherals, and wherein the peripherals comprises at least two ports to communicate with the TPMS device and the telematics device, respectively.

7. The universal receiver device as in claim 1, wherein the processing unit has storage means for maintaining updated information on the telematics device and the TPMS device to identify these devices.

8. The universal receiver device as in claim 1, wherein the processing unit comprises an interface block to control a power source to the telematics device and the TPMS device, respectively.

9. The universal receiver device as in claim 1, wherein the at least one data record comprises a data packet header, and ‘n’ data packets, where ‘n’ is the number of tires operatively mounted on the vehicle.

10. The universal receiver device as in claim 9, wherein the data packet header contains information selected from a group consisting of: time at which the data record was created, universal receiver device identification number, universal receiver device computer program version, telematics device identification number, TPMS device identification number, vehicle identification number, total number of bad transmissions per vehicle, and odometer reading of vehicle.

11. A method of interfacing between a tire pressure management system (TPMS) device, operatively installed to capture information associated with a vehicle's tire, and a telematics device, capable of wirelessly transmitting processed information to a remote processing unit, comprising steps of:
a) identifying a type of TPMS device to communicate therewith;
b) receiving the information associated with a vehicle's tire, previously captured by the TPMS device, in a communication format associated with the identified TPMS device in step a);
c) processing the information into at least one data record;
d) identifying a type of telematics device to communicate therewith; and
e) forwarding the at least one data record in a communication format associated with the identified telematics device in step d).

12. The method as in claim 11, wherein step c) further comprises storing the at least one data record.

13. The method as in claim 11, wherein step f) further comprises of transmitting the at least one data record to a remote processing unit.

14. The method as in claim 11, further comprising, prior to step a), the step of receiving communication from the TPMS device.

15. The method as in claim 11, further comprising, after step c) and prior to step d), the step of initiating communication with the telematics device.

16. The method as in claim 11, further comprising, after step c) and prior to step d), the step of receiving a communication request from the telematics device.

17. The method as in claim 11, wherein the method is a computer program running in a real time operating system environment.
